(19) United States
(12) Patent Application Publication
(10) Pub. No.: US 2016/0275849 A1
(43) Pub. Date: Sep. 22, 2016

(54) DISPLAY DEVICES

(71) Applicant: InnoLux Corporation, Miao-Li County (TW)

(72) Inventor: Yu-Sheng TSAI, Miao-Li County (TW)

(21) Appl. No.: 15/060,189

(22) Filed: Mar. 3, 2016

(30) Foreign Application Priority Data
Mar. 18, 2015 (CN) 201510118765.X

(51) Int. Cl. G09G 3/20

(52) U.S. Cl. CPC G09G 3/2092; G09G 2330/028; G09G 2300/0426

(57) ABSTRACT

A display device includes a driving circuit and an output circuit. The driving circuit generates a first output signal at a first output terminal according to an input signal and a first clock signal. The output circuit is coupled to the driving circuit at the first output terminal and generates a gate driving signal at a second output terminal according to the first output signal. The gate driving signal and the first output signal have the same waveform. The output circuit includes a first output transistor has a first terminal coupled to a first power source outputting a first operating voltage and has a second terminal coupled to the second output terminal and a second output transistor has a first terminal coupled to a second power source outputting the second operating voltage and has a second terminal coupled to the second output terminal.

### CROSS REFERENCE TO RELATED APPLICATIONS

This Application claims priority of China Patent Application No. 201510118765.X, filed on Mar. 18, 2015, the entirety of which is incorporated by reference herein.

### BACKGROUND OF THE INVENTION

1. Field of the Invention

The invention relates to a phase shifter, and more particularly to a full range phase shifter.

2. Description of the Related Art

Shift registers have been widely used in data driving circuits and gate driving circuits to control timing when receiving a data signal in each data line, as well as to generate a scanning signal for each gate line. In a data driving circuit, the shift register outputs a selection signal to each data line, so as to write the image data into each data line. In a gate driving circuit, the shift register outputs a scanning signal to each gate line, so as to write the image signal provided to each data line in the pixels of a pixel array.

A conventional shift register generates the selection signal or scanning signal in only a single direction. However, a single scanning direction does not satisfy the entire requirements of display products. For example, some displays of digital cameras are rotated according to the placement angle of the camera. In addition, some LCD monitors comprise the function of rotating the monitor. Therefore, novel bi-directional shift registers capable of outputting signals in a forward direction and a reverse direction, reducing power consumption, and further improving the driving capability, are highly desired.

### BRIEF SUMMARY OF THE INVENTION

Display devices are provided. An exemplary embodiment of a display device comprises a gate driving circuit. The gate driving circuit comprises a plurality of shift registers coupled in serial. At least one shift register comprises a driving circuit and an output circuit. The driving circuit generates a first output signal at a first output terminal according to an input signal and a first clock signal. The output circuit is coupled to the driving circuit at the first output terminal and generates a gate driving signal at a second output terminal according to the first output signal. The gate driving signal and the first output signal have the same waveform, and a first voltage level and a second voltage level of the gate driving signal are respectively driven by a first operating voltage and a second operating voltage. The output circuit comprises a first output transistor and a second output transistor. The first output transistor comprises a first terminal coupled to a first power source outputting the first operating voltage and a second terminal coupled to the second output terminal. The second output transistor comprises a first terminal coupled to a second power source outputting the second operating voltage and a second terminal coupled to the second output terminal.

An exemplary embodiment of a display device comprises a gate driving circuit. The gate driving circuit comprises a plurality of shift registers coupled in serial. At least one shift register comprises a driving circuit and an output circuit. The driving circuit comprises generates a first output signal at a first output terminal according to an input signal and a first clock signal. The driving circuit comprises a first driving transistor and a second driving transistor. The first driving transistor is coupled between a first clock input terminal receiving the first clock signal and the first output terminal. The second driving transistor comprises a first terminal coupled to the first output terminal and comprises a second terminal coupled to a first power source outputting a first operating voltage. The output circuit is coupled to the driving circuit at the first output terminal and generates a gate driving signal at a second output terminal. The output circuit comprises a first output transistor and a second output transistor. The first output transistor and the second output transistor are coupled in serial between the first power source and a second power source outputting a second operating voltage.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a block diagram of a display device according to an embodiment of the invention;

FIG. 2 shows an exemplary waveform of a clock signal;

FIG. 3 shows a block diagram of a bi-directional shift register circuit according to an embodiment of the invention;

FIG. 4 shows a block diagram of a shift register according to an embodiment of the invention;

FIG. 5 shows a circuit diagram of a shift register according to an embodiment of the invention;

FIG. 6 shows a circuit diagram of a shift register according to another embodiment of the invention;

FIG. 7A shows the waveforms of the control signals, start pulse and the clock signals in the forward scan according to an embodiment of the invention;

FIG. 7B shows the waveforms of the signals of the shift register in the forward scan according to an embodiment of the invention;

FIG. 8A shows the waveforms of the control signals, start pulse and the clock signals in the reverse scan according to an embodiment of the invention;

FIG. 8B shows the waveforms of the signals of the shift register in the reverse scan according to an embodiment of the invention;

FIG. 9A shows the waveforms of the control signals, start pulse and the clock signals in the forward scan according to another embodiment of the invention;

FIG. 9B shows the waveforms of the signals of the shift register in the forward scan according to another embodiment of the invention;

FIG. 10A shows the waveforms of the control signals, start pulse and the clock signals in the reverse scan according to another embodiment of the invention; and

FIG. 10B shows the waveforms of the signals of the shift register in the reverse scan according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

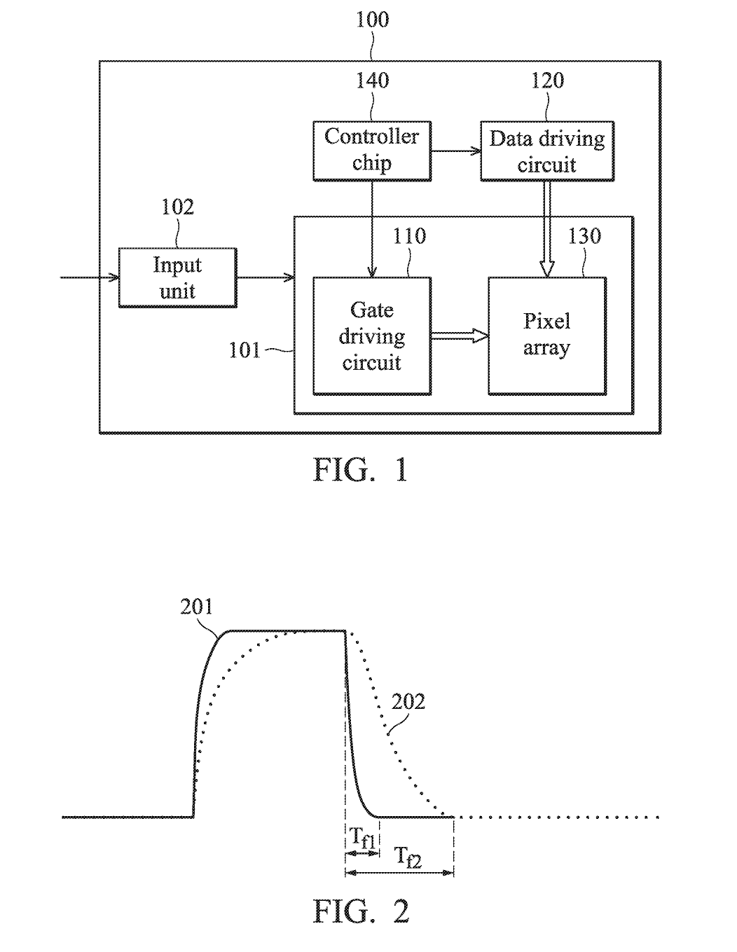

FIG. 1 is a block diagram of a display device according to an embodiment of the invention. As shown in FIG. 1, the display device 100 may comprise a display panel 101, a data driving circuit 120 and a controller chip 140. The display panel 101 may comprise a gate driving circuit 110 and a pixel array 130. The gate driving circuit 110 generates a plurality of gate driving signals to drive a plurality of pixels in the pixel array 130. The data driving circuit 120 generates a plurality of data driving signals to provide image data to the pixels of the pixel array 130. The controller chip 140 generates a plurality of timing signals, comprising clock signals, reset signals and start pulses.

In addition, the display device 100 may further comprise an input unit 102. The input unit 102 receives image signals and controls the display panel 101 to display images. According to an embodiment of the invention, the display device 100 may further be comprised in an electronic device. The electronic device may be implemented as various devices, comprising: a mobile phone, a digital camera, a personal digital assistant (PDA), a lap-top computer, a personal computer, a television, an in-vehicle display, a portable DVD player, or any apparatus with image display functionality.

According to an embodiment of the invention, the gate driving circuit 110 may be designed as a unilateral gate driving circuit and disposed at one side of the pixel array 130, or may be designed as a bilateral gate driving circuit and disposed at two sides of the pixel array, and the invention should not be limited to either implementation method. In addition, although in FIG. 1, the gate driving circuit 110 is disposed on the display panel 101, the invention should not be limited thereto. In other embodiments of the invention, the gate driving circuit 110 may also be not disposed on the display panel 101.

In addition, in an embodiment of the invention, according to the unilateral or bilateral design, the gate driving circuit 110 may comprise one or more shift register circuits. The shift register circuit may be a bi-directional shift register circuit for supporting the operations of two different scan directions (the forward scan and reverse scan). In the embodiments of the invention, the bi-directional shift register circuit may comprise a plurality of shift registers SR coupled in serial. Each shift register may sequentially generate a gate driving signal to one gate line for driving the pixels on each gate line. For example, when the bi-directional shift register circuit operates in the forward scan, the shift registers sequentially output the corresponding gate driving signals in a first order, such as SR(1)˜SR(M), where M is the number of shift registers and is a positive integer, and when the bi-directional shift register circuit operates in the reverse scan, the shift registers sequentially output the corresponding gate driving signals in a second order, such as SR(M)˜SR(1).

Generally, when the resolution of the display panel increases, the number of shift registers increases accordingly. However, once the number of shift registers increases, the loading of the clock signals provided to the shift register circuit increases, causing a distortion problem in the clock signals received by the shift register in the far end.

FIG. 2 shows an exemplary waveform of a clock signal. The waveform 201 represents the clock signal received by a near-end shift register and the waveform 202 represents the clock signal received by a far-end shift register. Here, the near end and far end represents the relative distance between the shift register and the controller chip providing the clock signals. As shown in FIG. 2, the falling time T_{f2} of the clock pulse received by the far-end shift register is longer than the falling time T_{f1} of the clock pulse received by the near-end shift register. However, the falling edge of the clock pulse is an important timing for reading the image data, especially when the clock signal is designed to have a pulse width of multiple horizontal times. Therefore, the falling time of the clock pulse is preferably as short as possible.

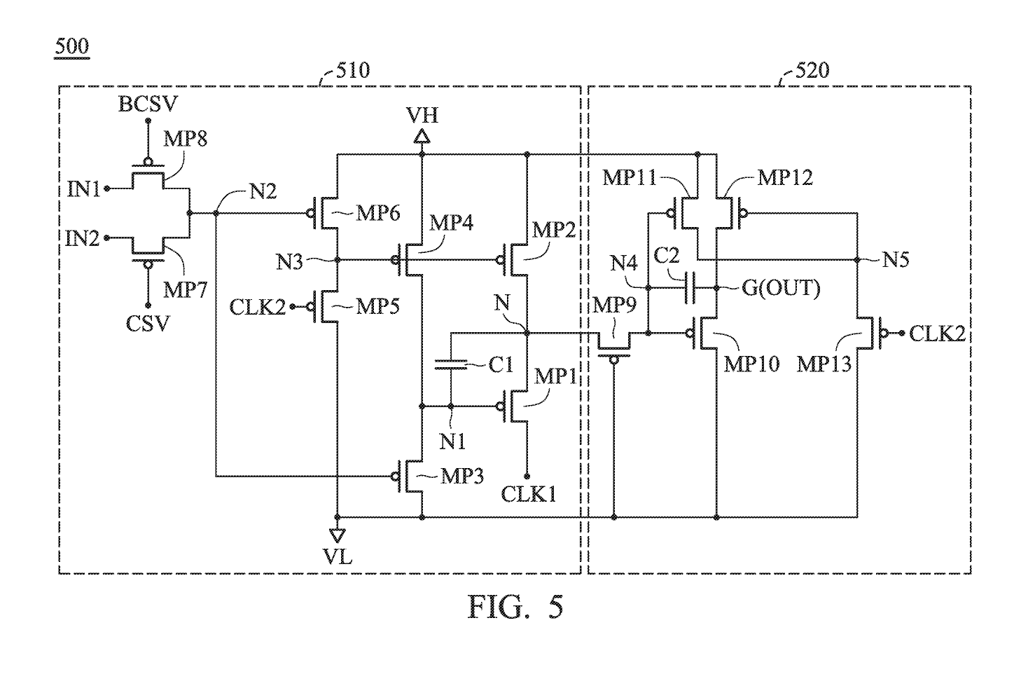

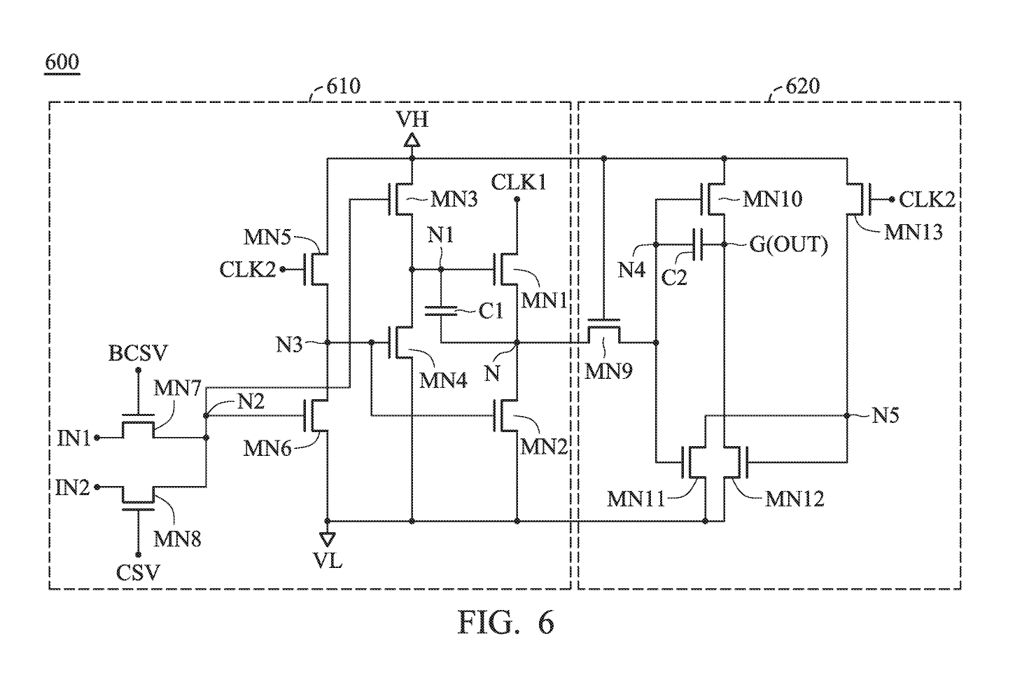

In this manner, the size of the transistor (for example, the transistors MP1 and MN1 in the embodiment as shown in FIGS. 5 and 6) outputting one pulse of the clock signal as the gate pulse of the gate driving signal in conventional design cannot be reduced, so as to prevent extending the falling time of the gate pulse. However, the big size transistor causes that the circuit area cannot be reduced and consumes more power. To solve this problem, bi-directional shift registers capable of reducing the size of transistor and further reducing power consumption are proposed. The proposed bi-directional shift registers are discussed further in the following paragraphs.

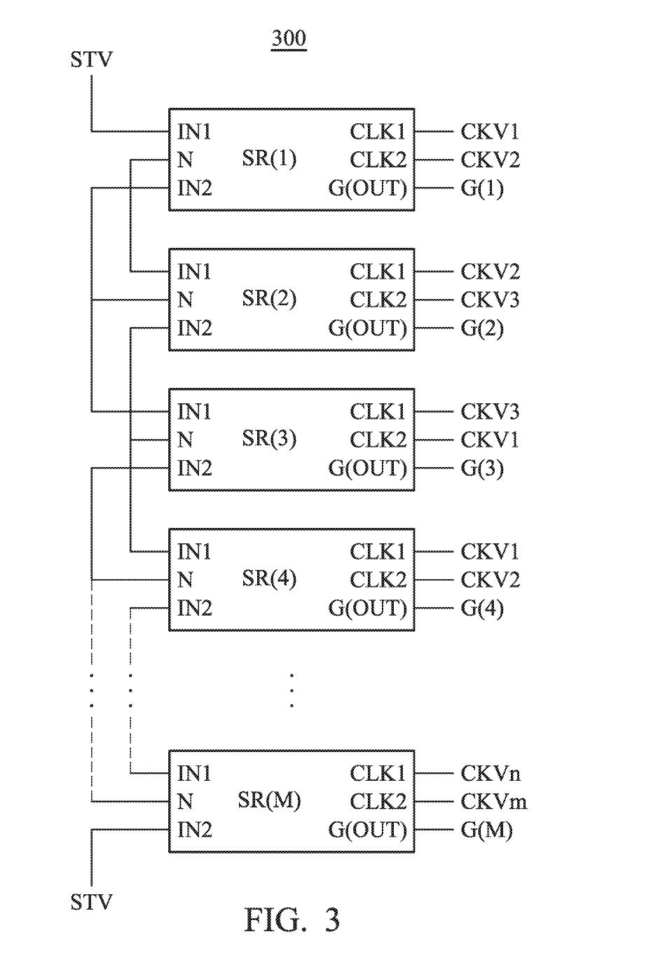

FIG. 3 shows a block diagram of a bi-directional shift register circuit according to an embodiment of the invention. As shown in FIG. 3, the bi-directional shift register circuit 300 may comprise a plurality of shift registers SR(1)˜SR(M) coupled in serial. Each shift register may at least comprise a first input terminal IN1, a second input terminal IN2, a first output terminal N, a second output terminal G(OUT), a first clock input terminal CLK1 and a second clock input terminal CLK2. The first stage shift register SR(1) receives, at the first input terminal IN1, the start pulse STV as the first input signal, and the remaining stage shift registers SR(2)˜SR(M) respectively receive, at the first input terminal IN1, the first output signal output by a previous stage shift register SR(1)˜SR(M-1) at the first output terminal N as the first input signal. The last stage shift register SR(M) receives, at the second input terminal IN2, the start pulse STV as the second input signal, and the remaining stage shift registers SR(M-1)˜SR(1) respectively receive, at the second input terminal IN2, the first output signal output by a following stage shift register SR(M)˜SR(2) at the first output terminal N as the second input signal.

Note that in the embodiments of the invention, since the first output signal output by the shift register at the first output terminal N and the second output signal output by the shift register at the second output terminal G(OUT) have the same waveform, in other embodiments of the invention, the bi-directional shift register circuit may also be designed so that the first stage shift register SR(1) receives, at the first input terminal IN1, the start pulse STV as the first input signal, and the remaining stage shift registers SR(2)˜SR(M) respectively receive, at the first input terminal IN1, the second output signal output by a previous stage shift register SR(1)˜SR(M-1) at the second output terminal G(OUT) as the first input signal. The last stage shift register SR(M) receives, at the second input terminal IN2, the start pulse STV as the second input signal, and the remaining stage shift registers SR(M-1)˜SR(1) respectively receive, at the second input terminal IN2, the second output signal output by a following stage shift register SR(M)˜SR(2) at the second output terminal G(OUT) as the second input signal. Therefore, the invention should not be limited to what is shown in FIG. 3.

In addition, in the embodiments of the invention, since the voltage level of the second output signal output at the second output terminal G(OUT) is driven by a power source (which will be discussed further in the following paragraphs), the voltage level thereof will not be substantially affected by the clock signal distortion (as shown in FIG. 2). Therefore, in the embodiments of the invention, the second output signal output by each shift register at the second output terminal G(OUT) will be provided as the gate driving signal thereof, such as the gate driving signals G(1), G(2), G(3), G(4) . . . G(M) as shown.

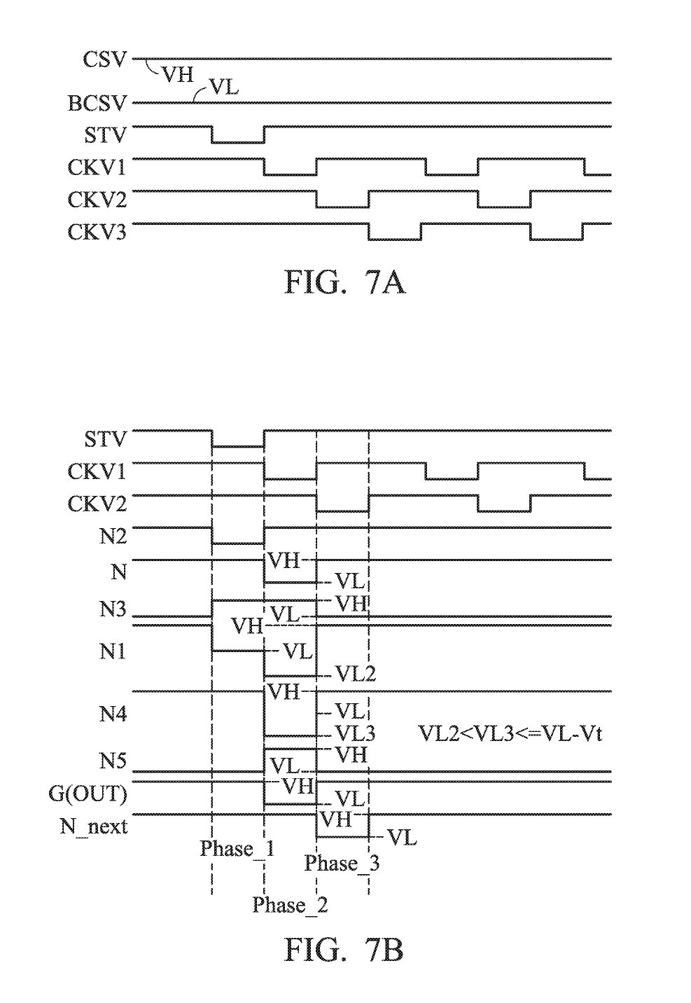

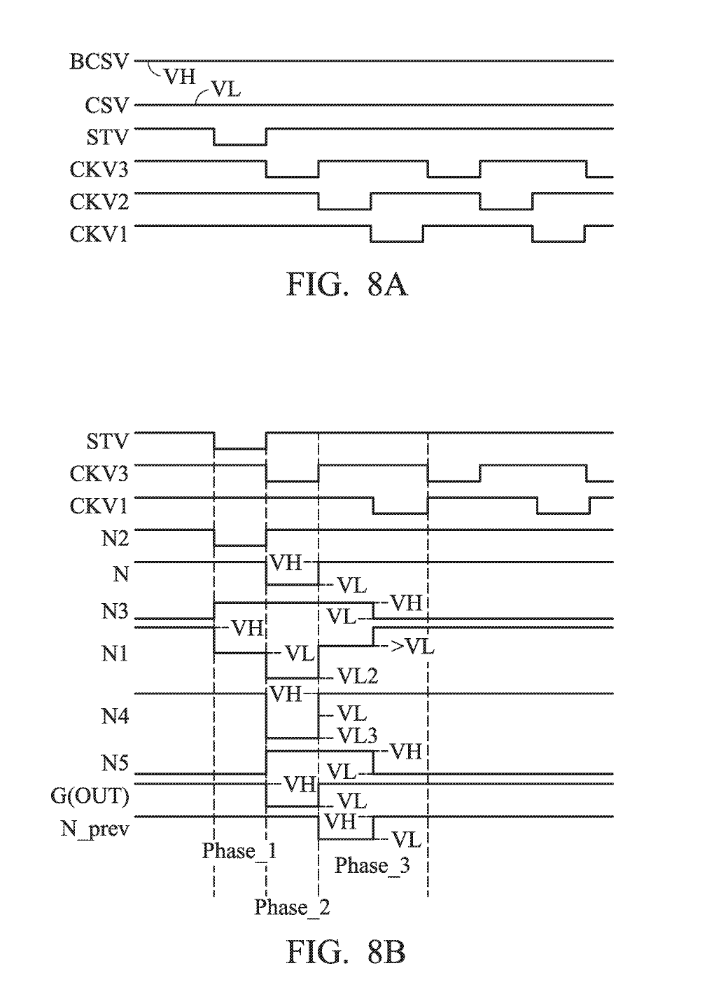

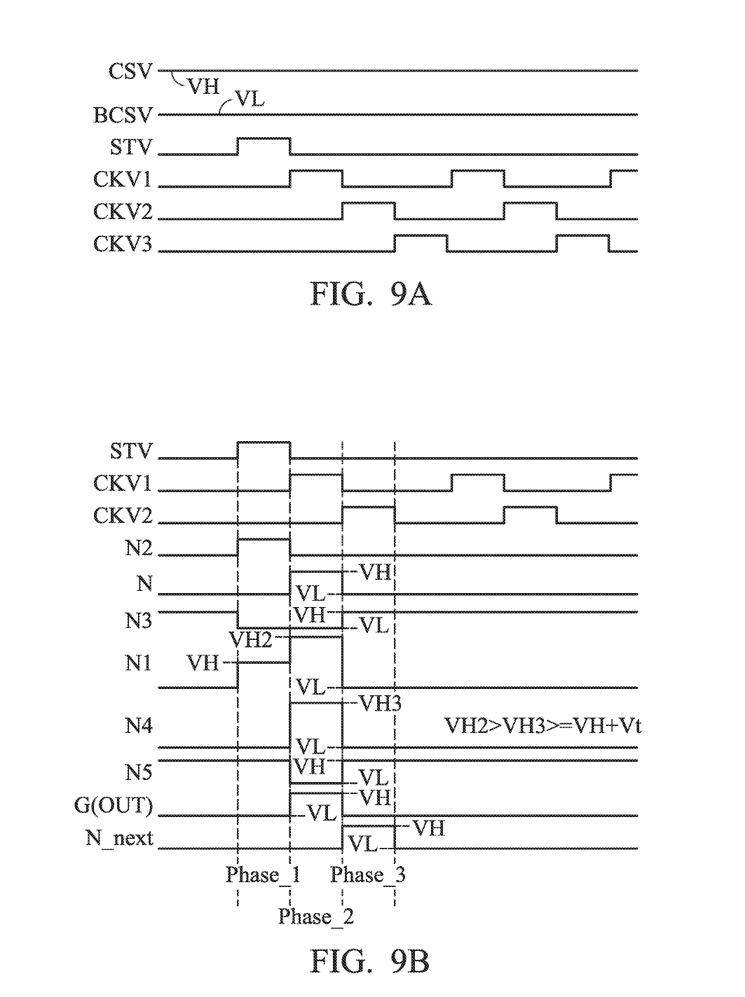

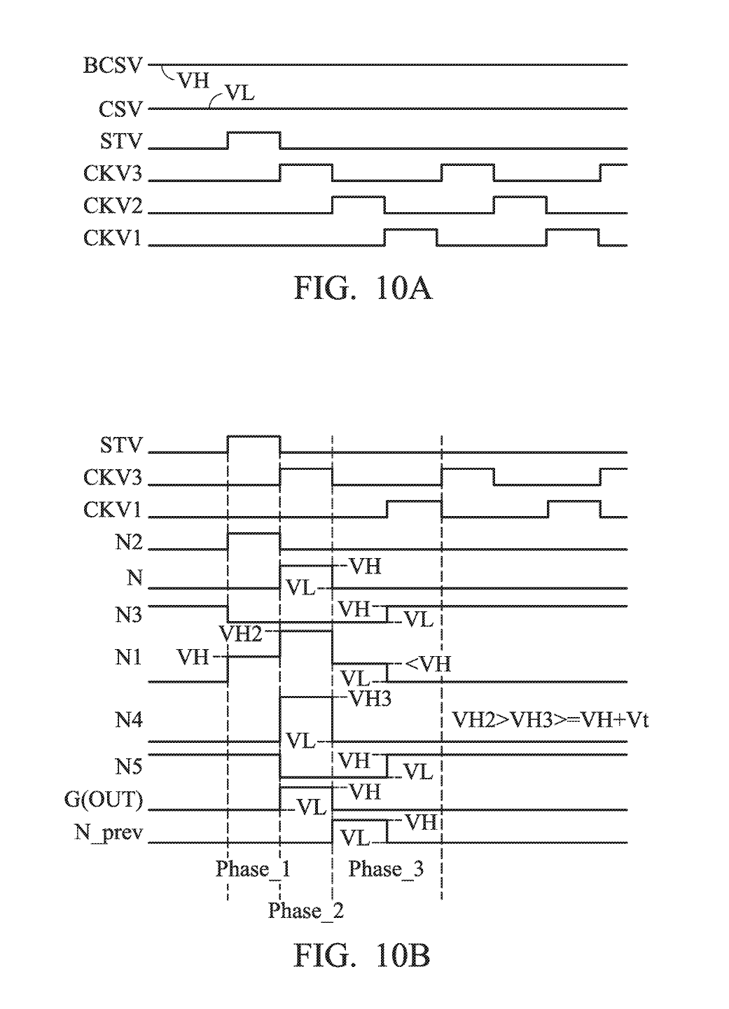

According to an embodiment of the invention, each shift register may receive two clock signals, such as two of the clock signals CKV1, CKV2 and CKV3 shown in the figure. As shown in FIG. 3, each shift register receives the clock signals at the clock input terminals in accordance with a predetermined rule. In the embodiment of the invention, a rising edge/falling edge of a clock signal is preferably close to a rising edge/falling edge of the next clock signal, but the invention should not be limited thereto. In addition, as shown in FIG. 7A and FIG. 9A, in the forward scan, the pulses of the clock signals CKV1-CKV3 are sequentially generated in a cyclic manner. As shown in FIG. 8A and FIG. 10A, in the reverse scan, the pulses of the clock signals CKV3-CKV1 are sequentially generated in a cyclic manner. Note that following the predetermined rule illustrated above, the clock signals CKVn and CKVm shown in FIG. 3 can be one of the clock signals CKV1, CKV2 and CKV3.

In addition, according to an embodiment of the invention, in the forward scan, operations of each shift register are activated in response to the first input signal received at the first input terminal IN1 and are deactivated in response to the clock signal received at the second clock input terminal CLK2. In the reverse scan, operations of each shift register are activated in response to the second input signal received at the second input terminal IN2 and are deactivated in response to the clock signal received at the second clock input terminal CLK2. The proposed shift register circuit is discussed in more detail in the following paragraphs.

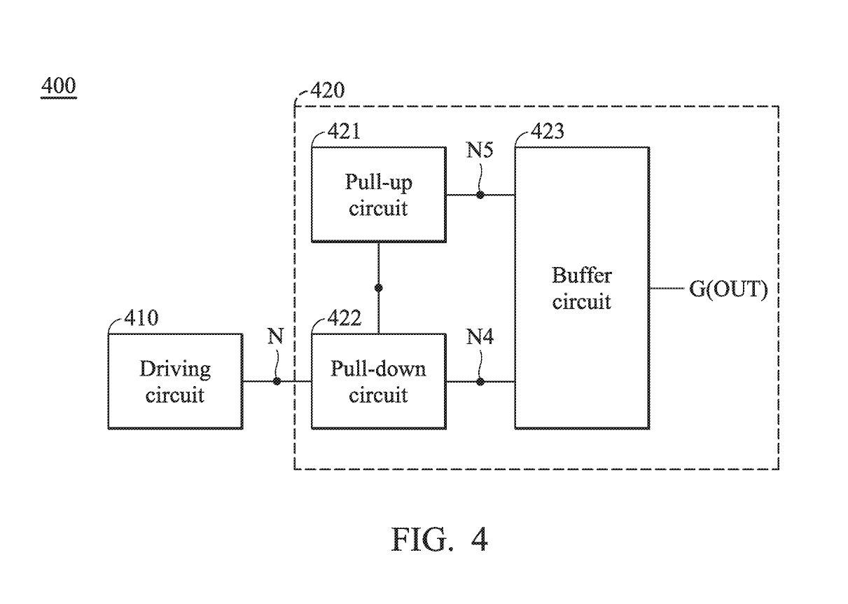

FIG. 4 shows a block diagram of a shift register according to an embodiment of the invention. According to an embodiment of the invention, the shift register 400 may comprise a driving circuit 410 and an output circuit 420. The driving circuit 410 may be any conventional gate driving circuit or a shift register circuit comprised in a gate driving circuit for generating the gate driving signal. The output circuit 420 may comprise a pull-up circuit 421, a pull-down circuit 422 and a buffer circuit 423.

According to an embodiment of the invention, the driving circuit 410 may generate a first output signal at the first output terminal N according to the input signal (such as the first input signal in forward scan or the second input signal in reverse scan) and the first clock signal received at the first clock input terminal CLK1. The driving circuit 410 and the output circuit 420 are coupled at the first output terminal N. The output circuit 420 generates a second output signal at the second output terminal G(OUT) as the gate driving signal according to the first output signal.

According to an embodiment of the invention, the buffer circuit 423 drives the gate driving signal according to the high operating voltage VH and the low operating voltage VL of the display device. The pull-up circuit 421 helps the buffer circuit 423 to pull up the voltage level at the second output terminal G(OUT) and the pull-down circuit 423 helps the buffer circuit 423 to pull down the voltage level at the second output terminal G(OUT). In the embodiments of the invention, via the output circuit 420, a first voltage level and a second voltage level of the gate driving signal generated by each shift register are respectively driven by the operating voltages of the display system instead of the clock signals. Since the voltage levels of the operating voltages of the display system are stable and have better driving capability, the distortion problem in the clock signals which will affect the gate driving signals in conventional designs can be solved, and the size of the transistor, and the power consumption can be reduced.

FIG. 5 shows a circuit diagram of a shift register according to an embodiment of the invention. In this embodiment, the transistors comprised in the shift register 500 are all PMOS transistors. The shift register 500 may comprise a driving circuit 510 and an output circuit 520. Note that the driving circuit 510 may be any conventional gate driving circuit or a shift register circuit comprised in a gate driving circuit for generating the gate driving signal. Therefore, the driving circuit 510 shown in FIG. 5 is only one of a plurality of driving circuit embodiments, and the invention should not be limited thereto.

According to an embodiment of the invention, the driving circuit 510 may comprise a plurality of driving transistors MP1-MP8 (hereinafter called transistors for simplicity) and a capacitor C1. The transistor MP1(the first driving transistor) is coupled between the first clock input terminal CLK1 and the first output terminal N and comprises a control electrode coupled to the control node N1. The transistor MP2 (the second driving transistor) is coupled between a first power source for outputting a first operating voltage and the first output terminal N and comprises a control electrode coupled to the control node N3. The transistor MP3 is coupled between the control node N1 and a second power source for outputting a second operating voltage and comprises a control electrode coupled to the control node N2. Note that in this embodiment, the first operating voltage is the higher than the second operation voltage. The first operating voltage may be the high operating voltage VH and the second operating voltage may be the low operating voltage VL as shown. The transistor MP4 is coupled between the control node N1 and the first power source and comprises a control electrode coupled to the control node N3. The transistor MP5 is coupled between the control node N3 and the second power source and comprise a control electrode coupled to the second clock input terminal CLK2. The transistor MP6 is coupled between the first power source and the control node N3 and comprises a control electrode coupled to the control node N2. The transistor MP7 is coupled between the control node N2 and the second input terminal IN2 and comprises a control electrode receiving the control signal CSV. The transistor MP8 is coupled between the control node N2 and the first input terminal IN1 and comprises a control electrode receiving the control signal BCSV. The capacitor C1 is coupled between the control node N1 and the first output terminal N.

The output circuit 520 may comprise a plurality of output transistors MP9-MP13 (hereinafter called transistors for simplicity). The transistor MP9 (the fifth output transistor) is coupled between the first output terminal N and the control node N4 and comprises a control electrode coupled to the second power source. The transistor MP10 (the second output transistor) is coupled between the second output terminal G(OUT) and the second power source and comprises a control electrode coupled to the control node N4. The transistor MP11 (the third output transistor) is coupled between the first power source and the control node N5 and comprises a control electrode coupled to the control node N4. The transistor MP12 (the first output transistor) is coupled between the first power source and the second output terminal G(OUT) and comprises a control electrode coupled to the control node N5. The transistor MP13 (the fourth output transistor) is coupled between the control node N5 and the second power source and comprises a control electrode coupled to the second clock input terminal CLK2. The capacitor C2 is coupled between the control node N4 and the second output terminal G(OUT).

FIG. 6 shows a circuit diagram of a shift register according to another embodiment of the invention. In this embodiment, the transistors comprised in the shift register 600 are all NMOS transistors. The shift register 600 may comprise a driving circuit 610 and an output circuit 620. Note that the driving circuit 610 may be any conventional gate driving circuit or a shift register circuit comprised in a gate driving circuit for generating the gate driving signal. Therefore, the driving circuit 610 shown in FIG. 6 is only one of a plurality of driving circuit embodiments, and the invention should not be limited thereto.

According to an embodiment of the invention, the driving circuit 610 may comprise a plurality of driving transistors MN1-MN8 (hereinafter called transistors for simplicity) and a capacitor C1. The transistor MN1(the first driving transistor) is coupled between the first clock input terminal CLK1 and the first output terminal N and comprises a control electrode coupled to the control node N1. The transistor MN2 (the second driving transistor) is coupled between a first power source for outputting the first operating voltage and the first output terminal N and comprises a control electrode coupled to the control node N3. The transistor MN3 is coupled between the control node N1 and a second power source for outputting the second operating voltage and comprises a control electrode coupled to the control node N2. Note that in this embodiment, the first operating voltage is the lower than the second operation voltage. The first operating voltage may be the low operating voltage VL and the second operating voltage may be the high operating voltage VH as shown. The transistor MN4 is coupled between the control node N1 and the first power source and comprises a control electrode coupled to the control node N3. The transistor MN5 is coupled between the control node N3 and the second power source and comprise a control electrode coupled to the second clock input terminal CLK2. The transistor MN6 is coupled between the first power source and the control node N3 and comprises a control electrode coupled to the control node N2. The transistor MN7 is coupled between the control node N2 and the first input terminal IN1 and comprises a control electrode receiving the control signal BCSV. The transistor MN8 is coupled between the control node N2 and the second input terminal IN2 and comprises a control electrode receiving the control signal CSV. The capacitor C1 is coupled between the control node N1 and the first output terminal N.

The output circuit 620 may comprise a plurality of output transistors MN9-MN13 (hereinafter called transistors for simplicity). The transistor MN9 (the fifth output transistor) is coupled between the first output terminal N and the control node N4 and comprises a control electrode coupled to the second power source. The transistor MN10 (the second output transistor) is coupled between the second output terminal G(OUT) and the second power source and comprises a control electrode coupled to the control node N4. The transistor MN11 (the third output transistor) is coupled between the first power source and the control node N5 and comprises a control electrode coupled to the control node N4. The transistor MN12 (the first output transistor) is coupled between the first power source and the second output terminal G(OUT) and comprises a control electrode coupled to the control node N5. The transistor MN13 (the fourth output transistor) is coupled between the control node N5 and the second power source and comprises a control electrode coupled to the second clock input terminal CLK2. The capacitor C2 is coupled between the control node N4 and the second output terminal G(OUT).

FIG. 7A shows the waveforms of the control signals, start pulse and the clock signals in the forward scan according to an embodiment of the invention. FIG. 7B shows the waveforms of the signals in the forward scan of the shift register according to an embodiment of the invention. The signal waveforms shown in FIG. 7A and FIG. 7B are those that correspond to the PMOS shift register 500 shown in FIG. 5. Accompanying the circuit shown in FIG. 5 with the waveforms shown in FIG. 7A and FIG. 7B, operations of the proposed shift register circuit are discussed further in the following paragraphs.

In the initial state, the voltage level at the control node N5 is set to a level of the low operating voltage VL so as to turn on the transistor MP12 and thus the voltage at the second output terminal G(OUT) is charged to the high voltage level VH through the transistor MP12.

In the first phase Phase_1, the pulse of input signal (for example, the start pulse STV shown in the figure, or the pulse of the first output signal or the second output signal output by a previous stage shift register) arrives, a voltage level at the control node N2 is pulled down so as to turn on the transistors MP3 and MP6. Meanwhile, the voltage at the control node N3 is pulled high to the high voltage level VH through the transistor MP6, thereby turning off the transistors MP4 and MP2 and pulling down the voltage level at the control node N1 to the low voltage level VL via the transistor MP3. The transistor MP1 is turned on in response to the low voltage level at the control node N1, and the clock signal (for example, the clock signal CKV1 shown in the figure) received at the first clock input terminal CLK1 is output at the first output terminal N as the first output signal. Meanwhile, since the pulse of the clock signal CKV1 has not yet arrived, the clock signal CKV1 still has a high voltage level. Therefore, the voltage level at the first output terminal N also has a high voltage level. Since the first output terminal N has a high voltage level, the transistor MP9 is turned on and thereby pulling up the voltage level at the control node N4. Thus, the transistors MP10 and MP11 are not turned on. In addition, since the control node N1 has a low voltage level and the first output terminal N has a high voltage level, a predetermined voltage difference is stored in the capacitor C1 coupled between the first output terminal N and the control node N1.

In the second phase Phase_2, the pulse of clock signal CKV1 arrives and the voltage level at the first output terminal N is pulled low at the same time. At this time, since a predetermined voltage difference is stored in the capacitor C1, the voltage at the control node N1 is pulled lower, such as the low voltage VL2 shown in the figure. In this manner, the transistor MP1 is completely turned on to completely output the pulse of the clock signal CKV1 to the first output terminal N as the first output signal. In addition, during the pull-low procedure of the voltage level at the first output terminal N, the transistor MP9 is turned on first, and then turned off (due to the change in the source-gate voltage Vsg of the transistor MP9). When the transistor MP9 is turned on, the voltage level at the control node N4 is pulled low because the voltage level at the first output terminal N is pulled low, thereby turning on the transistors MP10 and MP11. Since the voltage level at the first output terminal N is pulled low first, and then the voltage level at the control node N4 is pull low, another predetermined voltage difference is stored in the capacitor C2 coupled between the first output terminal N and the control node N4, and the predetermined voltage difference further pulls low the voltage at the control node N4, such as the low voltage VL3 shown in the figure. According to an embodiment of the invention, the relationship between the low voltages VL2 and VL3 is: VL2<VL3<=(VL−Vt), where Vt is the threshold voltage of the transistor.

In addition, since the transistors MP10 and MP11 are turned on in response to the low voltage level at the control node N4, the voltage at the second output terminal G(OUT) is discharged to the low voltage level VL via the transistor MP10 and the voltage at the control node N5 is pulled high to the high voltage level VH through the transistor MP11, thereby turning off the transistor MP12.

In the third phase Phase_3, the pulse of the clock signal CKV2 arrives, which turns on the transistors MP5 and MP13 and thereby turning off the voltages at the control nodes N3 and N5. At the same time, the transistors MP2 and MP4 are turned on and the voltage levels at the first output node N and the control node N1 are pulled high to the high voltage level VH. Since the first output terminal N is pulled high to the high voltage level, the transistor MP9 is turned on, thereby pulling up the voltage level at the control node N4. At the same time, the transistors MP10 and MP11 are turned off. In addition, the transistor MP12 is turned on in response to the low voltage level VL at the control node N5, and the voltage at the second output terminal G(OUT) is charged to the high voltage level VH through the transistor MP12. In addition, the first output terminal N_next of the following stage shift register outputs a gate pulse in response to the arrival of the pulse of the clock signal CKV2.

Note that in the embodiments of the invention, the high voltage level and the low voltage level of the gate driving signal output at the second output terminal G(OUT) are respectively triggered by the high operating voltage VH and the low operating voltage VL through the transistors MP10 and MP12. Therefore, the distortion problem in the clock signals which will affect the gate driving signals in conventional designs can be solved, and the size of the transistor (for example, the transistor MP1) and the power consumption can be reduced. In addition, in the embodiments of the invention, since the first output signal output at the first output terminal N and the second output signal (that is, the gate driving signal) output at the second output terminal G(OUT) of each shift register have the same waveform, anyone of the first output signal and the gate driving signal can be provided to the previous stage and the following stage shift register as the first and second input signal of the previous stage and the following stage shift register.

FIG. 8A shows the waveforms of the control signals, start pulse and the clock signals in the reverse scan according to an embodiment of the invention. FIG. 8B shows the waveforms of the signals of the shift register in the reverse scan according to an embodiment of the invention. The signal waveforms shown in FIG. 8A and FIG. 8B correspond to the signal waveforms of the PMOS shift register 500 shown in FIG. 5.

In the embodiments of the invention, since the scan direction of the shift register is controlled by the voltage levels of the control signals BCSV and CSV and the timing of the clock signals, operations of the shift register 500 in the forward scan are similar to that in the reverse scan and only different in that the time interval of the third phase Phase_3 is longer in the reverse scan than in the forward scan, which is due to the timing of the pulses of the clock signals received by the shift register. Therefore, in the reverse scan, the time durations for the control nodes N3 and N5 to have a high voltage level are longer than that in the forward scan, and the time duration for the control node N1 to have a low voltage level is longer than that in the forward scan. In addition, in the third phase Phase_3, the first output terminal Nprev of the previous stage shift register outputs a corresponding gate pulse in response to the arrival of the pulse of the clock signal CKV2.

Since the operations of the shift register 500 in the reverse scan are similar to that in the forward scan, discussions of the signal waveforms shown in FIG. 8A and FIG. 8B may refer to and derived from the descriptions regarding FIG. 7A and FIG. 7B, and are omitted here for brevity.

FIG. 9A shows the waveforms of the control signals, start pulse and the clock signals in the forward scan according to another embodiment of the invention. FIG. 9B shows the waveforms of the signals in the forward scan of the shift register according to another embodiment of the invention. The signal waveforms shown in FIG. 9A and FIG. 9B are those correspond to the NMOS shift register 600 shown in FIG. 6.

FIG. 10A shows the waveforms of the control signals, start pulse and the clock signals in the reverse scan according to another embodiment of the invention. FIG. 10B shows the waveforms of the signals of the shift register in the reverse scan according to another embodiment of the invention. The signal waveforms shown in FIG. 10A and FIG. 10B correspond to the signal waveforms of the NMOS shift register 600 shown in FIG. 6.

In the embodiments of the invention, the signal waveforms of the shifter register 600 operating in the forward scan and in the reverse scan are substantially the same as that of the shift register 500, and only reverse in the high voltage state and low voltage state of the corresponding signal waveforms. For example, in the second phase Phase_2, the voltage at the control node N1 is further pulled high to a level, such as the high voltage VH2 shown in the figures, higher than the high operating voltage VH due to the predetermined voltage difference stored in the capacitor C1. In addition, the voltage at the control node N4 is further pulled high to a level, such as the high voltage VH3 shown in the figures, higher than the high operating voltage VH due to the predetermined voltage difference stored in the capacitor C2. According to an embodiment of the invention, the relationship between the voltages VH2 and VH3 is VH2>VH3>=(VH+Vt), where Vt is the threshold voltage of the transistor.

Therefore, discussions of the signal waveforms shown in FIG. 9A, FIG. 9B, FIG. 10A and FIG. 10B are derived from the descriptions regarding FIG. 7A, FIG. 7B, FIG. 8A and FIG. 8B, and are omitted here for brevity.

As discussed above, in the embodiments of the invention, via the output circuit, the gate driving signal generated by each shift register is triggered by the operating voltages VH and VL of the display system instead of the clock signals. Since the voltage levels of the operating voltages of the display system are stable and have better driving capability, the distortion problem in the clock signals which will affect the gate driving signals in conventional designs can be solved, and the size of the transistor (for example, the transistor MP1) and the power consumption can be reduced.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A display device, comprising:
a gate driving circuit, comprising a plurality of shift registers coupled in serial, wherein at least one shift register comprises:
a driving circuit, generating a first output signal at a first output terminal according to an input signal and a first clock signal; and
an output circuit, coupled to the driving circuit at the first output terminal and generating a gate driving signal at a second output terminal according to the first output signal,
wherein the gate driving signal and the first output signal have the same waveform, and a first voltage level and a second voltage level of the gate driving signal are respectively driven by a first operating voltage and a second operating voltage, and wherein the output circuit comprises:
a first output transistor, comprising a first terminal coupled to a first power source outputting the first operating voltage and a second terminal coupled to the second output terminal; and
a second output transistor, comprising a first terminal coupled to a second power source outputting the second operating voltage and a second terminal coupled to the second output terminal.

2. The display device as claimed in claim 1, wherein the output circuit further comprises:
a third output transistor; and
a fourth output transistor,
wherein the third output transistor and the fourth output transistor are coupled in serial between the first power source and the second power source.

3. The display device as claimed in claim 2, wherein the second output transistor comprises a second control electrode coupled to a first control node, the first output transistor comprises a first control electrode coupled to a second control node, wherein the third output transistor comprises a third control electrode coupled to the first control node and the third output transistor comprises a first terminal coupled to the first power source and comprises a second terminal coupled to the second control node, and the fourth output transistor comprises a first terminal coupled to the second control node and comprises a second terminal coupled to the second power source and comprises a fourth control electrode receiving a second clock signal.

4. The display device as claimed in claim 3, wherein the output circuit further comprises:
a fifth output transistor, coupled between the first output terminal and the first control node and comprising a fifth control electrode coupled to the second power source; and
a capacitor, coupled between the first control node and the second output terminal.

5. The display device as claimed in claim 1, wherein the driving circuit comprises:
a first driving transistor, coupled between a first clock input terminal receiving the first clock signal and the first output terminal; and
a second driving transistor, comprising a first terminal coupled to the first output terminal and comprising a second terminal coupled to the first power source.

6. A display device, comprising:
a gate driving circuit, comprising a plurality of shift registers coupled in serial, wherein at least one shift register comprises:
a driving circuit, generating a first output signal at a first output terminal according to an input signal and a first clock signal, wherein the driving circuit comprises:
a first driving transistor, coupled between a first clock input terminal receiving the first clock signal and the first output terminal; and
a second driving transistor, comprising a first terminal coupled to the first output terminal and comprising a second terminal coupled to a first power source outputting a first operating voltage; and
an output circuit, coupled to the driving circuit at the first output terminal and generating a gate driving signal at a second output terminal, wherein the output circuit comprises:
a first output transistor; and
a second output transistor,
wherein the first output transistor and the second output transistor are coupled in serial between the first power source and a second power source outputting a second operating voltage.

7. The display device as claimed in claim 6, wherein the gate driving signal and the first output signal have the same waveform.

8. The display device as claimed in claim 6, wherein the second output transistor comprises a first terminal coupled to the second power source and a second terminal coupled to the second output terminal and comprises a second control electrode coupled to a first control node, the first output transistor comprises a first control electrode coupled to a second control node, and wherein the output circuit further comprises:
a third output transistor, comprises a first terminal coupled to the first power source and comprises a second terminal coupled to the second control node and comprises a third control electrode coupled to the first control node; and
a fourth output transistor, comprises a first terminal coupled to the second control node and comprises a second terminal coupled to the second power source and comprises a fourth control electrode receiving a second clock signal.

9. The display device as claimed in claim 8, wherein the output circuit further comprises:
a fifth output transistor, coupled between the first output terminal and the first control node and comprising a fifth control electrode coupled to the second power source; and
a capacitor, coupled between the first control node and the second output terminal.

10. The display device as claimed in claim 9, wherein any one of the first output signal and the gate driving signal is further provided to at least one of a previous stage or a following stage shift register as the input signal of the previous stage/following stage shift register.
